(19) United States
(12) Patent Application Publication
(10) Pub. No.: US 2009/0068910 A1
(43) Pub. Date: Mar. 12, 2009

(54) SYSTEMS AND METHODS FOR ELECTRONIC DEVICE HEAT DISSIPATION AND PADDING

(76) Inventors: Kevin Fredrick, Denver, CO (US); Curtis M. Duffus, Denver, CO (US); Fenghua Guo, (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 12/206,586

(22) Filed: Sep. 8, 2008

Related U.S. Application Data
(60) Provisional application No. 60/970,849, filed on Sep. 7, 2007.

(51) Int. Cl. D04B 1/00; B32B 37/00; C09D 11/00; D05B 21/00; B65B 63/04

(52) U.S. Cl. 442/314; 156/250; 106/31.3; 112/470.07; 53/430

(57) ABSTRACT

A pad according to embodiments of the present invention includes a cover layer, a second flexible layer next to the cover layer, the second flexible layer formed of warp knit textile, a third flexible layer formed of the warp knit textile, and nylon and/or polyester fibers connecting the second flexible layer with the third flexible layer. According to such embodiments, the plurality of fibers maintain a spaced-apart configuration of the second and third flexible layers. The cover layer, the second and third flexible layers, and the plurality of fibers between the second and third outer perimeters are fused together at an outer perimeter. The pad may be used under an electronic device to facilitate cooling of the electronic device, to increase a user's comfort when placed between the electronic device and the user's lap, or to protect, pad, and isolate the electronic device from spills on a table surface.

### CROSS-REFERENCE TO RELATED APPLICATIONS

This application claims the benefit of U.S. Provisional Patent Application Ser. No. 60/970,849, filed on Sep. 7, 2007, and entitled “Systems and Methods for Electronic Device Heat Dissipation and Padding,” which is incorporated by reference herein for all purposes.

### FIELD

Embodiments of the present invention relate to systems, methods and apparatus for heat dissipation of electronic devices and manufactures.

### BACKGROUND

Electronic devices, for example, laptop or notebook computers, DVD players, or CD players may become very hot during use. This may lead to discomfort of a user who works with the laptop or notebook computer on the user's leg or lap. The heat produced by laptop or notebook computers may also often decrease the lifespan of the computer or damage internal components if not dissipated well. Current pads which might be capable of use under a laptop or notebook computer or other device often do not include a structure conducive to airflow or heat dissipation, or often consist of a structure which frays, unravels, or deteriorates easily, particularly around the edges.

### SUMMARY

A pad according to embodiments of the present invention includes a cover layer with an outer perimeter, a second flexible layer next to the cover layer, the second flexible layer formed of warp knit textile and having a second outer perimeter, a third flexible layer formed of the warp knit textile and having a third outer perimeter, and a set of fibers connecting the second flexible layer with the third flexible layer. According to such embodiments, the plurality of fibers maintain a spaced-apart configuration of the second flexible layer and the third flexible layer while allowing flexibility of the second flexible layer and the third flexible layer. According to such embodiments of the present invention, the cover layer, the second and third flexible layers, and the plurality of fibers between the second and third outer perimeters are fused together at an outer perimeter to form a fused perimeter, and the cover layer, the second flexible layer, the plurality of fibers, and the third flexible layer are configured to permit easy passage of airflow therethrough.

Methods for making a pad according to embodiments of the present invention include cutting a flexible cover layer at a first outer perimeter, and cutting a spacer mesh layer at a second outer perimeter, such that the cut spacer mesh layer is shaped the same as the cut flexible cover layer. According to such embodiments, the spacer mesh layer includes top and bottom layers formed of a warp knit textile and a plurality of fibers connecting the top and bottom layers and maintaining a spaced-apart configuration of the top and bottom layers while allowing flexion of the top and bottom layers. Methods according to such embodiments further include aligning the flexible cover layer with the spacer mesh layer, fusing together the flexible cover layer, the top layer, and the bottom layer at the first and second outer perimeters to form a fused perimeter, and trimming any of the flexible cover layer or spacer mesh layer which protrudes beyond the fused perimeter. Such methods may further include depositing a rubberized ink on the flexible cover layer, according to embodiments of the present invention.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a pad in use between an electronic device and a user's lap, according to embodiments of the present invention.

FIG. 2 illustrates a top view of a pad, according to embodiments of the present invention.

FIG. 3 illustrates a bottom view of a pad, according to embodiments of the present invention.

FIG. 4 illustrates a partial cross-sectional view of a pad, according to embodiments of the present invention.

FIG. 5 illustrates an enlarged bottom view of a pad, showing a fused perimeter, according to embodiments of the present invention.

FIG. 6 illustrates an enlarged top view of a pad, showing a fused perimeter, according to embodiments of the present invention.

FIG. 7 illustrates a top view of a pad including rubberized ink deposited on the top layer and a border sewn over the fused perimeter, according to embodiments of the present invention.

FIG. 8 illustrates a method for making a pad, according to embodiments of the present invention.

FIG. 9 illustrates a cutting mold for making a pad, according to embodiments of the present invention.

FIG. 10 illustrates an upper plate blank and lower die base for making a pad, according to embodiments of the present invention.

FIG. 11 illustrates a spacer mesh layer placed over a cover layer over a lower die base, according to embodiments of the present invention.

FIG. 12 illustrates a side perimeter of a spacer mesh layer and cover layer compressed between an upper plate blank and lower die base during ultrasonic fusing of the spacer mesh layer and cover layer, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

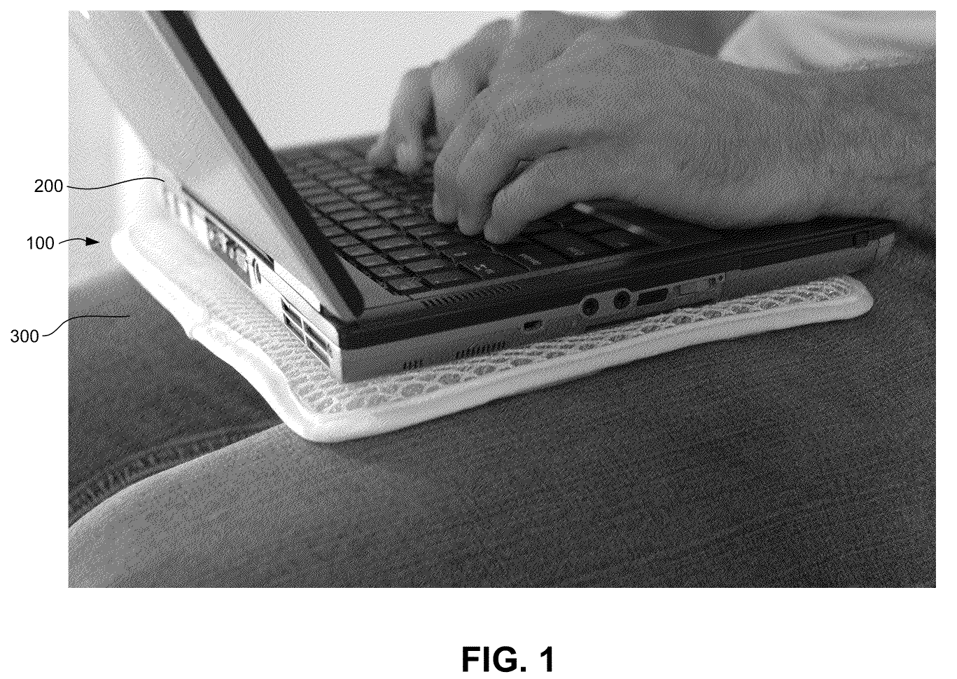

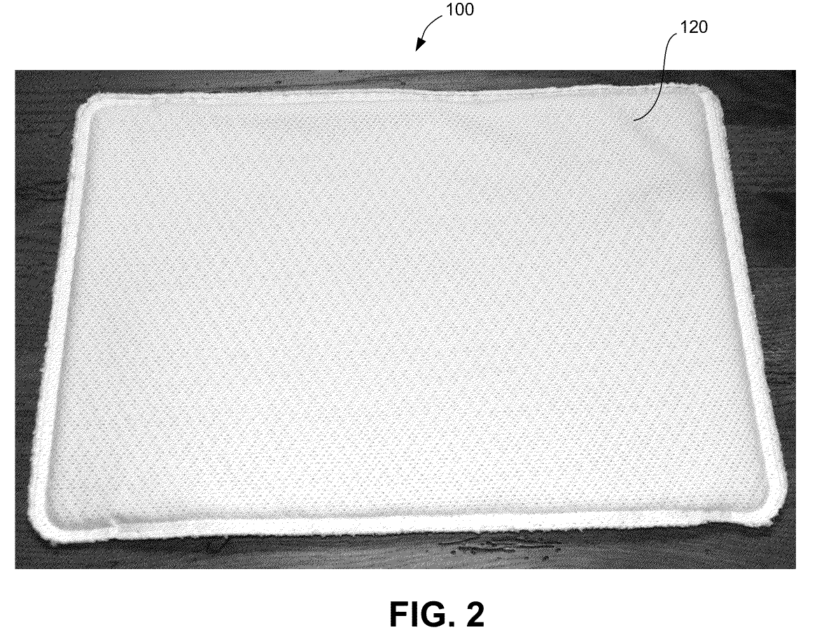

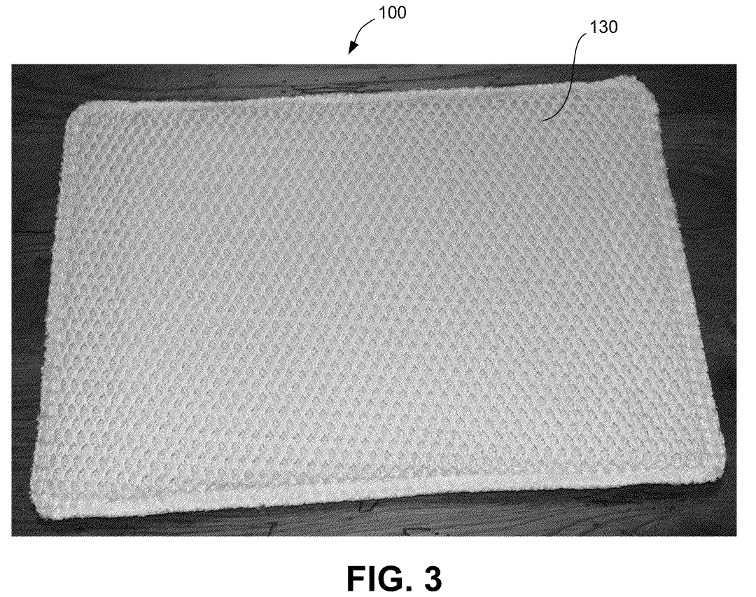

FIG. 1 illustrates a lightweight pad 100 in use between an electronic device 200 and a user's lap 300, according to embodiments of the present invention. FIG. 2 illustrates a top view of a pad 100, according to embodiments of the present invention. FIG. 3 illustrates a bottom view of a pad 100, according to embodiments of the present invention. Embodiments of the present invention can keep a user's legs 300 cool when used between the user's legs 300 and a heat-generating electronic device 200, such as, for example, a laptop or notebook computer.

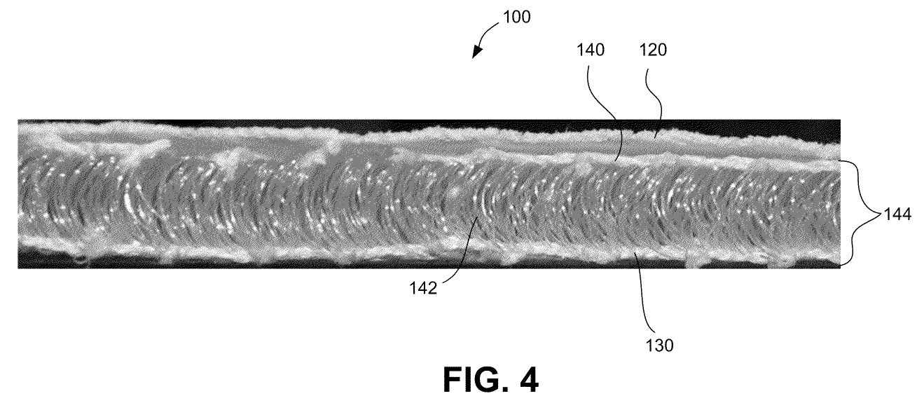

FIG. 4 illustrates a partial cross-sectional view of a pad 100, according to embodiments of the present invention. Heat dissipating pads 100 according to embodiments of the present invention include top 140 and bottom 130 layers of warp knit textile with nylon and/or polyester fibers 142 fused, woven, wound or otherwise connected between the top 140 and bottom 130 layers. The nylon and/or polyester fibers 142 between the layers 140, 130 serve to provide lateral support between the top and bottom layers 140, 130 while still permitting flexibility of the pad 100, deflection or depression of one or both layers 140, 130, and open spaces for airflow through, within, and/or around the pad 100. The combination of top layer 130, bottom layer 142, and the plurality of nylon and/or polyester fibers 142 between them may be referred to as spacer mesh 144. According to some embodiments, a three-dimensional spacer mesh 144 may be acquired as product number SHR832 from Gerhring Textiles of Suite 300, 1225 Franklin Ave, Garden City, N.Y., 11530. According to other embodiments, the pad 100 can include, but is not limited to, a polyester fabric cover layer 120 on the top and/or the bottom; optionally, such fabric cover layer 120 may be imprinted with a visual design and/or logo, according to embodiments herein. Such fabric cover layer 120 may alternatively be constructed of cotton, nylon and/or polyester, Coolmax™, Spandex™, Kevlar™, fabric blends or other suitable covering materials, according to embodiments of the present invention.

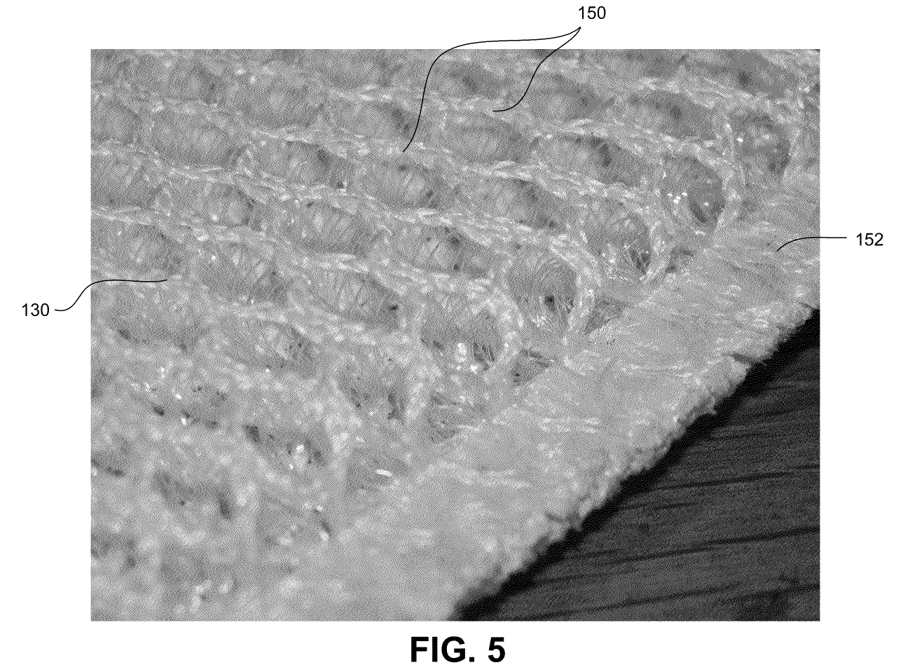

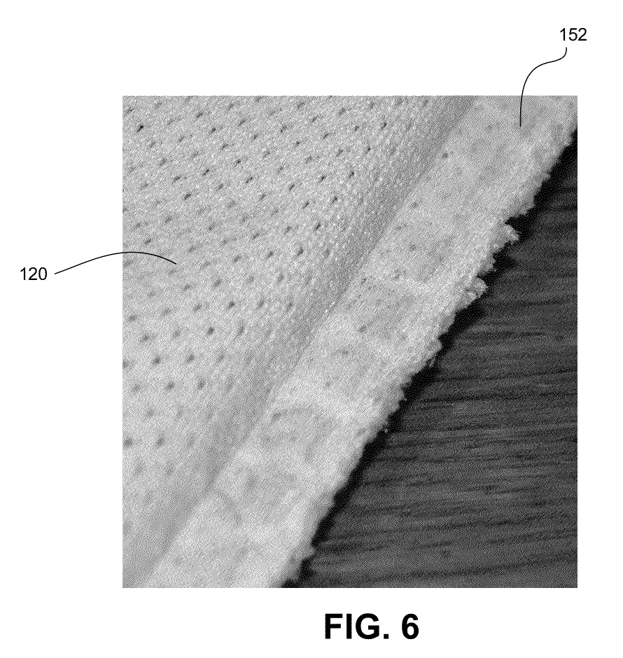

FIG. 5 illustrates an enlarged bottom view of a pad 100, showing bottom layer 130 and a fused perimeter 152, according to embodiments of the present invention. FIG. 6 illustrates an enlarged top view of a pad 100, showing a cover layer 120 and a fused perimeter 152, according to embodiments of the present invention. According to embodiments of the present invention, the spacer mesh 144 (including layers 140, 130, and fibers 142) and the cover layer 120 may be compressed and fused together along a fused perimeter 152. Such fusion secures the cover layer 120 to the spacer mesh 144, and also compresses and holds together the layers 120, 130, 140, and fibers 142 and renders the pad 100 more aesthetically pleasing. Fusing the layers 120, 130, and 140 at the fused perimeter 152 (e.g. at the perimeters of each of the respective layers 120, 130, 140) also minimizes fraying at the edges of the pad 100 to improve the appearance and minimize snagging and tangling of unraveling loose edges of the spacer mesh 144, according to embodiments of the present invention. According to some embodiments of the present invention, the cover layer 120 is fused to the spacer mesh 144 only at the fused perimeter 152.

FIG. 5 also illustrates that the bottom layer 130 includes a substantially repeating pattern of roughly hexagonal-shaped cells 150. These cells 150 resemble a honeycomb pattern, according to embodiments of the present invention. The hexagonal cells 150 provide a sturdy textile surface while permitting a large degree of airflow through the layer 130. Top layer 140 is similar to bottom layer 130, according to embodiments of the present invention. The nylon and/or polyester fibers 142 connect the hexagonal cells 150 of the bottom layer 130 with the hexagonal cells 150 of the top layer 140, according to embodiments of the present invention.

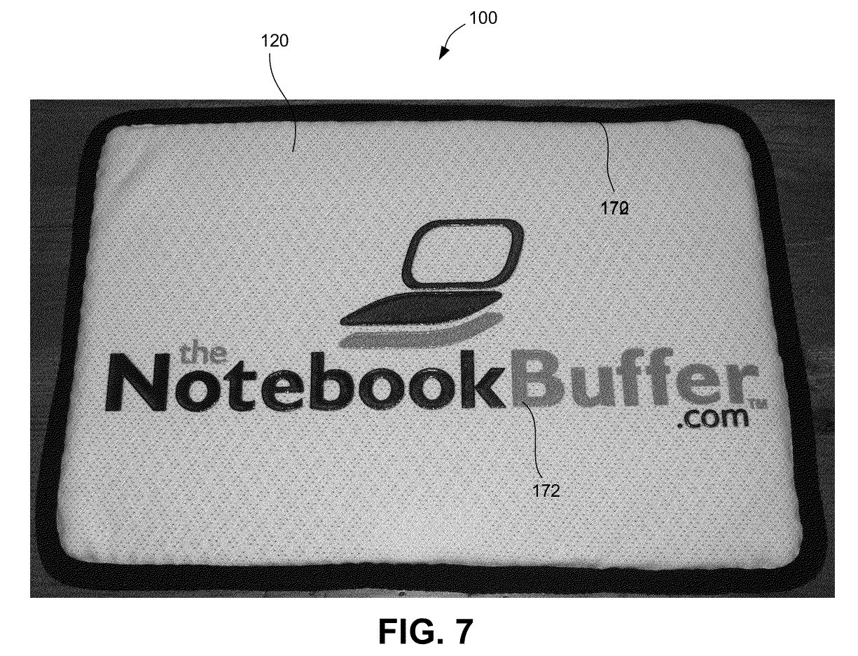

FIG. 7 illustrates a top view of a pad 100 including rubberized ink 172 deposited on the top layer 120 and a border 170 sewn over the fused perimeter 152, according to embodiments of the present invention. According to some embodiments of the present invention, a design and/or logo may be printed, stamped, airbrushed, or otherwise formed directly on the cover layer 120. Although the warp knit textile of the layers 130, 140 may be more difficult to print on, a design and/or logo may be printed, stamped, airbrushed, or otherwise formed directly on the warp knit pattern material 130, 140, according to embodiments of the present invention.

According to some embodiments, the cover layer 120 with rubberized ink 172 deposited thereon may be used in an upwardly-facing direction when for example, used between a laptop computer and a user's lap, especially for electronic devices 200 that do not include very effective traction control devices on their undersides. In such cases, the rubberized ink 172 grips the underside of the electronic device 200 and minimizes slippage and/or sliding of the electronic device 200 with respect to the pad 100. Pad 100 may also be used with the cover layer 120 in a downward-facing direction when used on a table top (to minimize sliding and/or slippage of the pad 100 with respect to the table top or other underlying surface), and/or when used with an electronic device 200 with adequate traction control devices on its underside, according to embodiments of the present invention.

Although a cover layer 120 made of mesh fabric permits a large amount of air passage through the mesh fabric, by comparison the warp knit textile layers 130, 140 permit an even higher degree of air passage due to their smaller surface area and more open configuration. Thus, pad 100 may be a dual-sided device whose use can be customized according to the needs of the user, and whose use can be adapted to accommodate different electronic devices 200 and/or usage preferences at different times. For example, a user of an electronic device 200 with a cooling fan on the bottom of the device 200 may opt to use the pad 100 with the bottom layer 130 facing upwardly to maximize airflow of the cooling fan. Such a configuration permits the cooling fan of the electronic device 200 to operate in the manner in which it was designed by the electronic device 200 manufacturer, rather than by actively inducing certain airflows and/or temperature gradients that often enhance the problems associated with electronic device 200 overheating and/or causation of uncomfortably hot usage conditions. Because each electronic device 200 is different, it is difficult for such “active” cooling devices to properly interact with the electronic devices 200, whereas the “passive” cooling system of embodiments of the present invention spaces the electronic device 200 from underlying obstacles to more effectively permit the electronic device 200 to cool itself as it was designed to do.

Even when the pad 100 according to embodiments of the present invention is used on a table or other surface instead of a lap 300, the pad 100 operates to isolate the electronic device 200 from liquid or food spills on the table, and permits the airflow currents of the room or other surrounding environment to pass naturally under and around the electronic device 200, according to embodiments of the present invention. A pad 100 according to embodiments of the present invention may also roll easily for transport and/or storage, and may also be packaged along with the electronic device 200 to provide further cushioning of the electronic device 200. For example, the pad 100 may be folded around a bottom end of an electronic device 200 before insertion of the electronic device 200 into a carrying bag, so the pad 100 helps cushion impact associated with setting down or dropping the bag. The pad 100 may also be placed in parallel with the electronic device 200 within a carrying bag on the outer side of the carrying bag to further cushion and/or protect from side impacts, according to embodiments of the present invention.

Although an electronic device 200 is described with respect to laptop or notebook computers, one of ordinary skill in the art, based on the disclosure herein, will appreciate that embodiments of the present invention may be used with various other electronic or non-electronic devices 200 for heat dissipation, padding, and/or comforting the user during use. Based on the disclosure provided herein, one of ordinary skill in the art will appreciate that the dimensions of the pad 100 may be varied; for example, the thickness of the spacer mesh 144 may be varied between two and fifteen millimeters, and the outer shape of the pad 100 may be rectangular, square, circular, oval, or otherwise shaped to accommodate different devices 200, according to embodiments of the present invention.

According to some embodiments of the present invention, wrinkling of the printed cover layer and/or other layers and/or the edges of the mesh material may be minimized through the use of a vinyl layer. Beginning with a cut but otherwise unfinished piece of spacer mesh 144 or an air mesh material, a layer of vinyl may be sewed to the bottom of the mesh material, according to embodiments of the present invention. A cover 120 may be sewn on the top of the mesh material, and a binding edge 170 may be sewn around the perimeter of the mesh material, also securing the vinyl layer and the cover to the mesh material. Then, the vinyl layer may be cut next to the binding edge on the bottom side of the mesh material to expose the mesh material underneath, while retaining a strip of the vinyl layer under the binding edge for better perimetric stability of the pad 100 and/or minimization of wrinkles.

According to some embodiments of the present invention, a cardboard material may be used instead of a vinyl layer. For example, beginning with a cut but otherwise unfinished spacer mesh 144, a layer of cardboard may be sewed to the bottom of the spacer mesh 144, according to embodiments of the present invention. A cover 120 may be sewn on the top of the mesh material, and a binding edge 170 may be sewn around the perimeter of the mesh material, also securing the cardboard layer and the cover to the mesh material. Then, the cardboard layer may be cut next to the binding edge on the bottom side of the mesh material to expose the mesh material underneath, while retaining a strip of the cardboard layer under the binding edge for better perimetric stability of the pad and/or minimization of wrinkles. According to alternative embodiments of the present invention, the cardboard layer may be removed completely after stitching of the binding edge 170.

According to other embodiments of the present invention, the binding edge may be sewed around the perimeter of the mesh material without use of a vinyl pad or other additional perimetric stabilizer. The binding edge 170, which may be constructed of nylon and/or polyester fiber or other suitable material, compresses, seals, and finishes the perimetric edges of the layers 120, 130, 140, and serves to discourage or hide unraveling or deterioration of the outer edges of those layers, according to embodiments of the present invention. The binding edge 170 may be coupled with or fastened around the perimeter of the layers 120, 130, 140 in a number of different ways, such as, for example, stitching, gluing, or stapling, according to embodiments of the present invention. According to some embodiments of the present invention, a stiffer binding material may be attached around the perimeter of the layers 120, 130, 140, such as, for example, Polypro, Nylike, and/or Herringbone, according to embodiments of the present invention.

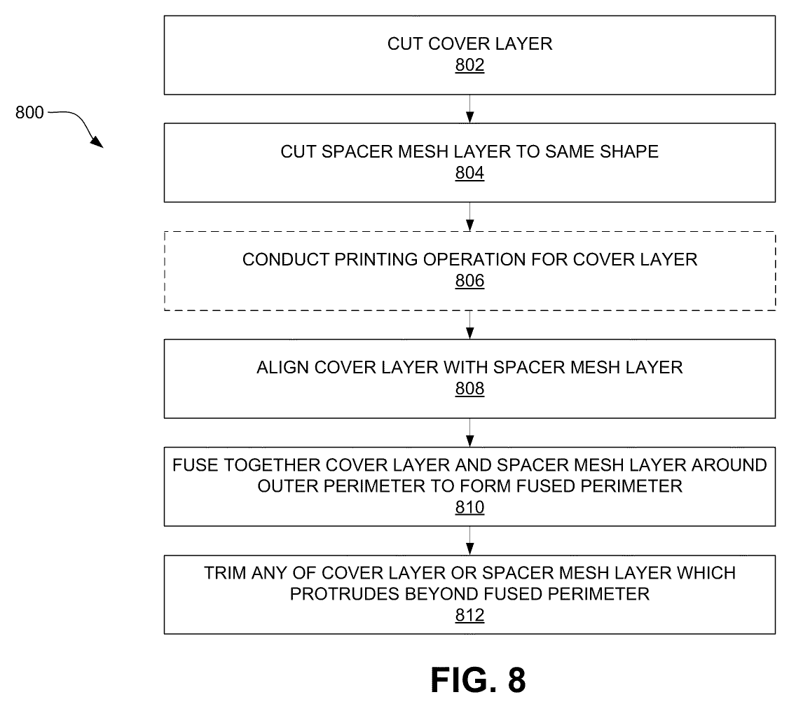

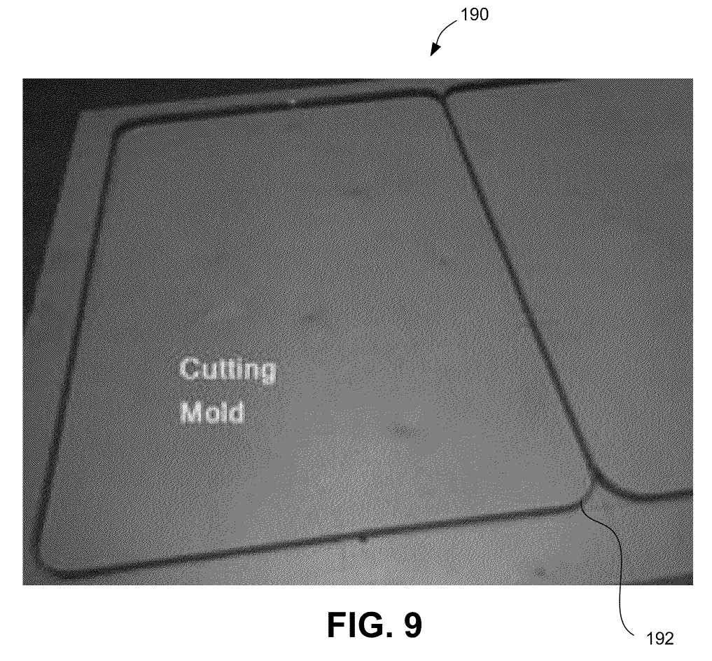

FIG. 8 depicts a flow chart 800 illustrating a method for making a pad 100, according to embodiments of the present invention. The materials that comprise the different layers 120, 144 may first be gathered. The cover layer 120 may be cut to the appropriate size (block 802). The spacer mesh layer 144 may be cut to the appropriate size, to match and/or align with the cover layer 120 (block 804). This cutting operation may be accomplished with the cutting mold 190 depicted in FIG. 9, which may include one or more templates in the shape of the pad 100, including rounded edges 192. According to some embodiments of the present invention, rubberized ink may be deposited on the cover layer 120 (block 806). This printing operation is optional, and may occur either before or after the cutting operation (block 802). The printing may include a customized logo and/or trademark, according to embodiments of the present invention. According to some embodiments of the present invention, the layers 120 and 144 may be cut in the cutting operations (blocks 802, 804) to leave an additional width of material in each layer (for example, one centimeter), to facilitate the later fusing operation.

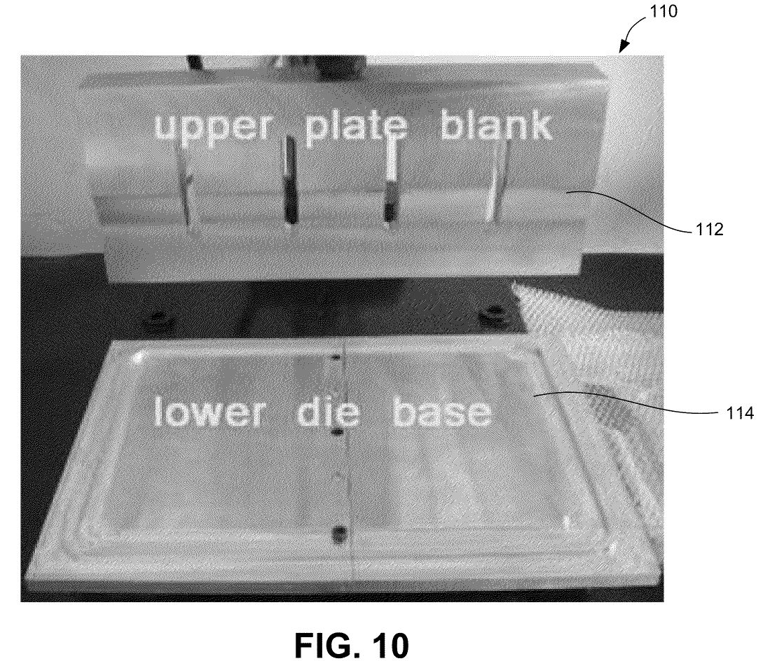

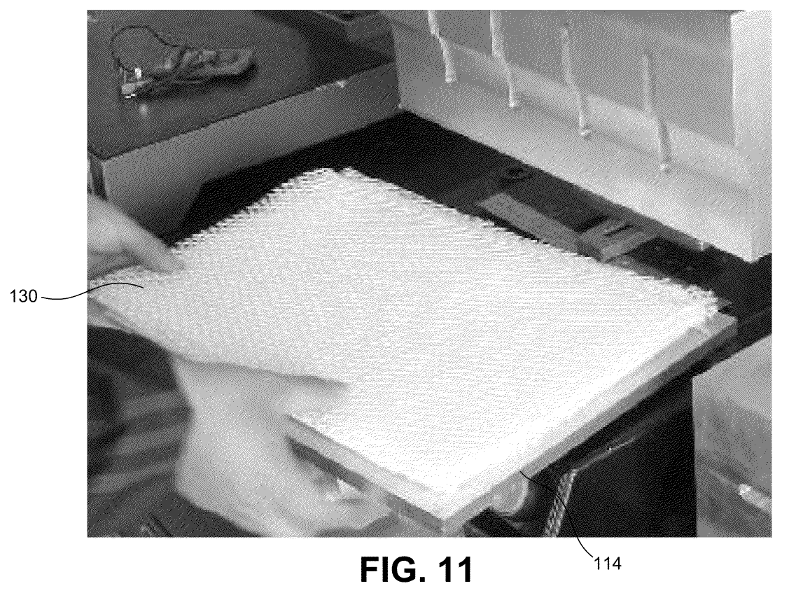

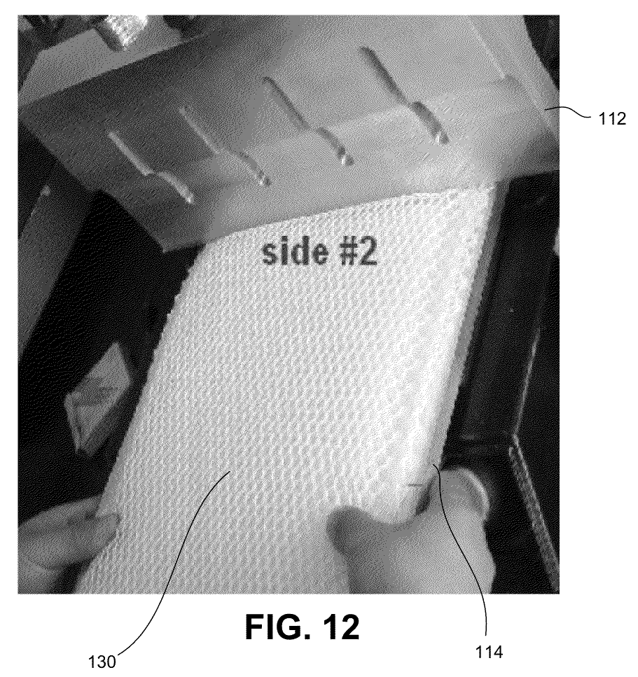

The cover layer 120 may be aligned with the spacer mesh layer 144 (block 808). The cover layer 120 and the spacer mesh layer 144 may then be fused together, according to embodiments of the present invention. This may be accomplished with an ultrasonic fusing mold 110 illustrated in FIG. 10. The ultrasonic fusing mold includes an upper plate blank 112 and a lower die base 114, according to embodiments of the present invention. As illustrated in FIG. 11, the cover layer 120 may be placed on the lower die base 114, and the spacer mesh layer 144 may be aligned (block 808) and placed over the cover layer 120, according to embodiments of the present invention. As illustrated in FIG. 12, the upper plate blank 112 may be lowered to compress the spacer mesh layer 144 and cover layer 120 together between the upper plate blank 112 and lower die base 114, in order to perform a fusing operation (block 810).

The fusing operation may be an ultrasonic fusing and/or ultrasonic welding operation, according to embodiments of the present invention. The fusing operation may also be a thermal fusing operation, and/or may involve the compression of layers and application of a glue or other substance to bind and/or fuse the layers 120, 130, 140 and fibers 142 together, according to embodiments of the present invention. Use of a synthetic material for each layer 120, 130, 140 and fibers 142 permits easier fusion of the layers at the fusion perimeter 152, according to embodiments of the present invention. Each side of the pad 100 may be fused in a fusing operation (block 810) as shown in FIG. 12 until each of the sides has been fused to create the fused perimeter 152, according to embodiments of the present invention. According to other embodiments of the present invention, an ultrasonic fusing mold 110 is capable of fusing all four sides at the same time to create the entire fused perimeter 152 in a single operation. Once the fused perimeter 152 has been made, any excess material extending past the fused perimeter 152 (such as, for example, the excess width of material left after the cutting operation in blocks 802, 804) may be trimmed (block 812). A synthetic textile border 170 may optionally be sewn over the outer perimeter of the pad 100, for example at the fused perimeter 152, according to embodiments of the present invention.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A pad comprising:
a first flexible layer, wherein the first flexible layer is a cover layer having a first outer perimeter;
a second flexible layer next to the first flexible layer, the second flexible layer formed of warp knit textile and having a second outer perimeter;
a third flexible layer formed of the warp knit textile and having a third outer perimeter; and
a plurality of fibers connecting the second flexible layer with the third flexible layer, the plurality of fibers maintaining a spaced-apart configuration of the second flexible layer and the third flexible layer while allowing flexion of the second flexible layer and the third flexible layer,
wherein the first, second, and third flexible layers and the plurality of fibers between the second and third outer perimeters are fused together at the first, second, and third outer perimeters to form a fused perimeter, and wherein the first flexible layer, the second flexible layer, the plurality of fibers, and the third flexible layer are configured to permit passage of airflow therethrough.

2. The pad of claim 1, wherein the first flexible layer is fused to the second and third flexible layers only at the first outer perimeter.

3. The pad of claim 1, wherein the flexible cover layer is nylon mesh.

4. The pad of claim 1, wherein the plurality of fibers is a plurality of nylon fibers, and wherein the plurality of nylon fibers is woven integrally with the warp knit textile of the first and second flexible layers.

5. The pad of claim 1, wherein the first flexible layer comprises an inner surface configured to abut the second flexible layer and an outer surface, the pad further comprising:
a rubberized ink deposited on the outer surface.

6. The pad of claim 1, further comprising:
a synthetic textile border sewn over the fused perimeter.

7. The pad of claim 1, wherein the pad is configured to be rolled up for storage or transport.

8. A method for making a pad, comprising:
cutting a flexible cover layer at a first outer perimeter;
cutting a spacer mesh layer at a second outer perimeter, the cut spacer mesh layer shaped the same as the cut flexible cover layer, wherein the spacer mesh layer includes:
top and bottom layers formed of a warp knit textile, and
a plurality of fibers connecting the top and bottom layers and maintaining a spaced-apart configuration of the top and bottom layers while allowing flexion of the top and bottom layers;
aligning the flexible cover layer with the spacer mesh layer;
fusing together the flexible cover layer, the top layer, and the bottom layer at the first and second outer perimeters to form a fused perimeter; and
trimming any of the flexible cover layer or spacer mesh layer which protrudes beyond the fused perimeter.

9. The method of claim 8, further comprising:
depositing a rubberized ink on the flexible cover layer.

10. The method of claim 9, further comprising:
depositing the rubberized ink on the flexible cover layer before fusing together the flexible cover layer, the top layer, and the bottom layer.

11. The method of claim 8, wherein fusing together the flexible cover layer, the top layer, and the bottom layer comprises compressing together and then ultrasonically fusing together the flexible cover layer, the top layer, and the bottom layer.

12. The method of claim 8, further comprising:
sewing a synthetic textile border over the fused perimeter.

13. The method of claim 8, further comprising:
rolling the pad for storage or transport.

14. A dual-sided electronic device cooling system, comprising:
a first side comprising a mesh fabric;
rubberized ink deposited on the first side;
a second side comprising a warp-knit textile;
an inner layer comprising the warp-knit textile; and
a plurality of fibers connecting the second side to the inner layer and configured to maintain a spaced-apart configuration of the second side and the inner layer, the first side, the second side, and the inner layer fused together along an outer perimeter,
wherein the rubberized ink of the first side is configured for direct contact with an underside of an electronic device for improved traction of the electronic device with respect to the first side, and wherein the second side is configured or direct contact with the underside for improved cooling and less traction.

15. The dual-sided electronic device cooling system of claim 14, wherein the first side, second side, and the inner layer are ultrasonically fused together along the outer perimeter.

16. The dual-sided electronic device cooling system of claim 15, wherein the first side, second side, and the inner layer are ultrasonically fused together only along the outer perimeter.

17. The dual-sided electronic device cooling system of claim 14, wherein the mesh fabric is a nylon mesh fabric.

18. The dual-sided electronic device cooling system of claim 14, wherein the plurality of fibers is a plurality of nylon fibers, and wherein the plurality of nylon fibers is woven integrally with the warp knit textile of the second side and the inner layer.

19. The dual-sided electronic device cooling system of claim 14, further comprising:
a synthetic textile border sewn over the outer perimeter.

20. The dual-sided electronic device cooling system of claim 14, wherein the dual-sided electronic device cooling system is configured to be rolled up for storage or transport.
